(19) United States
(12) Patent Application Publication
(10) Pub. No.: US 2026/0074300 A1
(43) Pub. Date: Mar. 12, 2026

(54) Adhesive Solid Electrolyte Interphase via Direct Contact Formation

(71) Applicant: Zeta Energy LLC, Houston, TX (US)

(72) Inventors: Abdul-Rahman Olabode Raji, Houston, TX (US); Yavuz Savsatli, Houston, TX (US); Sarathy K. Gopalakrishnan, Houston, TX (US); Tuo Wang, Houston, TX (US); Tuqeer Nasir, Sugar Land, TX (US); Rodrigo Villegas Salvatierra, Houston, TX (US)

(21) Appl. No.: 19/233,182

(22) Filed: Jun. 10, 2025

Related U.S. Application Data
(60) Provisional application No. 63/663,150, filed on Jun. 23, 2024.

(51) Int. Cl. H01M 10/42; H01M 4/62

(52) U.S. Cl. CPC H01M 10/4235; H01M 4/621; H01M 4/625

(57) ABSTRACT

A structure for electrochemical cells includes a conductive sheet, a layer of conductive nanomaterial, such as carbon nanotubes, on the sheet's surface, and a dry, ionically conductive adhesive, comprising a solid electrolyte interphase (SEI), binding the nanomaterial. A method forms the structure by coating a conductor with the nanomaterial, wetting it with an electrolyte solution, and decomposing the electrolyte, often via electrode contact, to create the SEI. The SEI enhances mechanical resilience and uniform lithium plating, reducing safety risks in lithium-metal batteries. The scalable process simplifies electrode fabrication, supporting high-performance, durable anodes for electrochemical applications.

### CROSS REFERENCE TO RELATED APPLICATION

This application claims the benefit of provisional U.S. application 63/663,150 filed 23 Jun. 2024 entitled “Adhesive Solid Electrolyte Interphase via Direct Contact Formation,” which is incorporated herein by reference.

### BACKGROUND

Carbon nanotubes (CNTs) have demonstrated promising capabilities as lithium host materials in lithium-metal batteries due to their high electrical conductivity and mechanical strength. However, their application is restricted by their susceptibility to mechanical damage, particularly in larger cell formats like prismatic and cylindrical cells. Mechanical damage, such as scratching, has detrimental effects on the electrochemical performance of the cells, leading to non-uniform lithium electroplating and increased safety risks, such as thermal runaway.

### BRIEF DESCRIPTION OF THE DRAWINGS

FIG. 1 depicts a system 100 for producing a layered structure 105 of electrode material for electrochemical cells.

### DETAILED DESCRIPTION

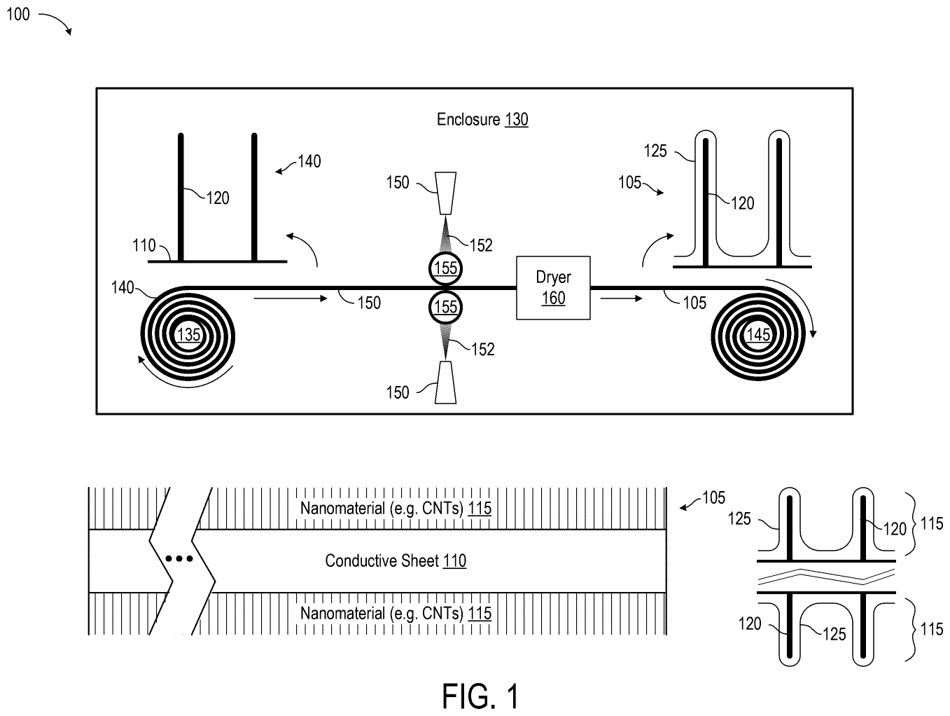

FIG. 1 depicts a system 100 for producing a layered structure 105 of electrode material for electrochemical cells. A cross-section of layered structure 105 is shown at the bottom. Referring to the cross section, layered structure 105 includes a conductive sheet 110 having layers of conductive nanomaterial 115 on either side of the sheet. In this example, the nanomaterials are carbon nanotubes (CNTs) 120 that extend from sheet 100 and are covered with an adhesive layer of dry Solid Electrolyte Interphase (SEI) material 125.

Structure 105 may serve as a double-sided anode in an electrochemical cell or cells. Nanomaterial 115 can be or include graphite, carbon, metal oxides, metal hydroxides, and carbon nanomaterials. Conductive sheet 110 can be e.g. of copper, aluminum, carbon, or a combination of these and other materials. In one anode embodiment, the nanomaterial consists principally of vertically aligned carbon nanotubes (CNTs) grown on or from a copper instance of sheet 110. SEI 125 binds CNTs 120 together and to conductive sheet 110. The resultant material is compatible with subsequent anode-formation processes, simplifies handling and cell assembly, and improves the mechanical resilience of assembled cells. CNTs can be arranged differently in other embodiments, such as disordered or in non-vertical alignment.

Layered structure 105 is assembled within an enclosure 130 that allows formation within an environment that can be controlled. The assembly is produced via a so-called “roll-to-roll” machine in this embodiment. Roll-to-roll deposition minimizes material waste and scales for high throughput and efficiency, all of which is important for large-scale production and cost-effectiveness. Roll-to-roll implementations are not exclusive, however.

A source roll 135 of a dry, adhesive-free web 140 is spooled onto a receiving role 145. In route, nozzles 150 spray an electrolyte solution 152 on respective electrodes 155, rollers in this example, of or covered with a metal (e.g. Lithium). Electrodes 155 wet web 140 with electrolyte solution 152 in contact with the metal to form SEI 125. Electrolyte solution 152 can be e.g. LiTFSI (Lithium bis(trifluoromethanesulfonyl)imide) in Dimethoxyethane (DME)/Dioxolane (DOL), Lithium hexafluorophosphate in ethylene carbonate and dimethyl carbonate, (LiPF₆ in EC/DMC), or Lithium difluoro(oxalato)borate (LiDFOB) in ethylene carbonate (EC) and ethyl methyl carbonate (EMC)

Components of electrolyte 152 function as reducing agents. SEI 125 forms on and between CNTs 120. Conductive electrodes 155 are in contact with and electrically short-circuited with CNTs 120. In the case of a copper conductive sheet 110 and lithium electrodes 155, the resultant reducing environment decomposes solvents and salts of electrolyte 152 on CNTs 120 to form SEI 125 at the interface between the electrolyte the surfaces of CNTs 120. For example, organic solvents (like ethylene carbonate, dimethyl carbonate, etc.) can undergo reduction reactions on the surfaces of CNTs 120, leading to the formation of various compounds that constitute SEI layer 120. The composition of SEI layer 120 can vary depending on factors like the material of sheet 110, electrolyte composition, and the type of metal used in metal contacts 155. Some components that can be found in SEI 125 include lithium fluoride (LiF), lithium hydroxide (LiOH), and lithium carbonate (Li₂CO₃).

The wet web 140, now with SEI 125, passes through a dryer 160. The resulting web with dry, ionically conductive SEI 125 binding CNTs 120 to conductive sheet 110 is, in this example, wound on receiving roll 145. As is conventional, the terms “wet” and “dry” here describe the presence and absence of a liquid or moisture on a solid surface.

Web 140 can partially encircle electrodes 155 for increased contact area and concomitant contact time, and more and larger electrodes can be used. Initial experiments have shown that exposing web 140 to electrolyte-wetted lithium for eight hours yields a robust SEI layer 125. With shorter durations, such as 15 minutes, electrolyte solution 152 may not fully wet CNT web 140 for closely spaced CNTs. Incomplete wetting can lead to uneven or partial formation of SEI at the base of the CNTs.

SEI 125 is an amorphous, polymeric structure that enhances mechanical resilience and reduces the susceptibility of the CNTs to mechanical degradation. SEI 125 also provides a protective layer for 3D nanomaterial hosts like those used in silicon and lithium anodes. These anodes undergo substantial volume changes during cycling, changes that exert mechanical forces that can damage the 3D structure formed by the nanomaterial. SEI 125 mitigates such risks. The enhanced durability provided by SEI 125 also addresses safety concerns by reducing the risk of non-uniform lithium plating, and thereby mitigating the risks of premature cell failure and thermal runaway.

The process of FIG. 1 starts with a roll 135 of copper film with each side covered with a carpet of CNTs. Suitable processes for growing CNTs from a copper conductive sheet are detailed in US Publication 2022/0209216 to Salvatierra et al., which is incorporated herein by reference. Any ambiguity in claim construction should favor meanings derived from this disclosure over that publication.

SEI can form on and bind nanomaterials other than CNTs. Common materials on which SEI can form include graphite and other forms of carbon (like hard carbon, soft carbon, etc.), silicon, composites (like carbon-silicon composites), and lithium titanate (LTO). The nanomaterials can be selected from a group consisting of multi-walled carbon nanotubes, single-walled carbon nanotubes, few-walled carbon nanotubes, graphene nanoribbons, graphene nanoplatelets, and mixtures thereof. Other nanomaterials more or less suitable for anode or cathode applications might also be used. For example, CNT carpets can be used to create supercapacitors, light-absorbing surfaces for sensitive optical instruments, or highly sensitive biosensors. CNT carpets can be grown on a variety of substrates, such as silicon wafers or glass slides, by chemical vapor deposition. Once grown, CNTs can be functionalized with various biomolecules, such as antibodies or enzymes, to create biosensors for a wide range of analytes, including small molecules, proteins, and DNA.

While lithium metal is used for electrolyte decomposition and SEI formation in the foregoing examples, SEI formation and concomitant nanomaterial adhesion can be accomplished using other materials. For example, Lithium Titanate (LTO), zinc, lead, cadmium, or sodium, are anode materials that might be used in combination with different substrates.

The electrolyte in the forgoing embodiments consists of a lithium salt in an organic solvent. Other salts and solvents can be used. Moreover, various additives can aid in SEI formation, additives such as lithium bis(oxalato)borate (LiBOB) and lithium difluoro(oxalato)borate (LiDFOB). Wetting agents can also be included to improve the wetting of the nanomaterials by electrolyte solution 152, substances like dimethyl carbonate (DMC) or diethyl carbonate (DEC).

While the subject matter has been described in connection with specific embodiments, other embodiments are also envisioned. Other variations will be evident to those of skill in the art. Therefore, the spirit and scope of the appended claims should not be limited to the foregoing description. Only those claims specifically reciting “means for” or “step for” should be construed in the manner required under the sixth paragraph of 35 U.S.C. § 112.

What is claimed is:

1. A structure comprising:
a sheet having a surface;
a layer of conductive nanomaterial on the surface; and
a dry, ionically conductive adhesive binding the conductive nanomaterial.

2. The structure of claim 1, wherein the layer of conductive nanomaterial is between the surface and the ionically conductive adhesive.

3. The structure of claim 1, wherein the ionically conductive adhesive comprises a decomposition byproduct of a metal and an electrolyte solution.

4. The structure of claim 3, wherein the metal consists essentially of lithium.

5. The structure of claim 3, wherein the electrolyte solution comprises a lithium salt.

6. The structure of claim 1, wherein the ionically conductive adhesive comprises a solid electrolyte interphase (SEI) material.

7. The structure of claim 1, wherein the conductive nanomaterial is bonded to the surface.

8. The structure of claim 7, wherein the conductive nanomaterial consists primarily of carbon nanotubes.

9. The structure of claim 8, wherein the carbon nanotubes are aligned perpendicular to the surface.

10. The structure of claim 1, wherein the ionically conductive adhesive comprises a metallic salt.

11. The structure of claim 10, wherein the metallic salt comprises an alkali metal cation.

12. The structure of claim 10, wherein the ionically conductive adhesive comprises an organic compound.

13. The structure of claim 12, wherein the organic compound is a carbonate.

14. A method comprising:
coating a conductor with a nanomaterial;
wetting the nanomaterial with an electrolyte solution containing an electrolyte; and
decomposing the electrolyte on the nanomaterial to form a solid electrolyte interphase on the nanomaterial.

15. The method of claim 14, wherein the decomposing comprises contacting the electrolyte solution with an electrode.

16. The method of claim 15, wherein the wetting occurs before the contacting.

17. The method of claim 14, wherein the nanomaterial is conductive.

18. The method of claim 14, wherein the nanomaterial is bonded to the conductor.

19. The method of claim 14, wherein the nanomaterial consists primarily of carbon nanotubes and the solid electrolyte interphase is over and between the carbon nanotubes.

20. The method of claim 19, wherein the carbon nanotubes are aligned perpendicular to a surface of the conductor.
